(19) United States
(12) Patent Application Publication
(10) Pub. No.: US 2023/0106934 A1
(43) Pub. Date: Apr. 6, 2023

(54) CHARGER MANAGING METHOD

(71) Applicant: Ford Global Technologies, LLC, Dearborn, MI (US)

(72) Inventors: Stuart C. Salter, White Lake, MI (US); Ryan O'Gorman, Beverly Hills, MI (US); William Wurz, San Francisco, CA (US); Peter Phung, Windsor (CA); David Kennedy, Canton, MI (US)

(21) Appl. No.: 17/492,960

(22) Filed: Oct. 4, 2021

(51) Int. Cl. B60L 53/62; H02J 7/00; H02J 3/00; B60L 53/68; G05B 19/042

(52) U.S. Cl. CPC B60L 53/62; H02J 7/0013; H02J 3/003; H02J 7/00032; B60L 53/68; G05B 19/042; H02J 7/0048; G05B 2219/2639

(57) ABSTRACT

A pop-up charger management method includes assessing an expected charge demand based on communications from a plurality of electrified vehicles, and, in response to the expected charge demand, starting at least one generator of a pop-up charger. A pop-up charger assembly can include at least one generator; at least one battery; a control module configured to, in response to an expected charge demand, start the at least one generator, the expected charge demand based on communications from a plurality of electrified vehicles.

### TECHNICAL FIELD

This disclosure relates generally to managing a charger that charges electrified vehicles and, in particular, a pop-up charger.

### BACKGROUND

Some vehicles are electrified vehicles having traction batteries that can be recharged. Pop-up chargers can be used to charge the traction batteries.

### SUMMARY

In some aspects, the techniques described herein relate to a pop-up charger management method, including: assessing an expected charge demand based on communications from a plurality of electrified vehicles; and, in response to the expected charge demand, starting at least one generator of a pop-up charger.

In some aspects, the techniques described herein relate to a pop-up charger management method, wherein the pop-up charger is a vehicle-mounted pop-up charger.

In some aspects, the techniques described herein relate to a pop-up charger management method, wherein the pop-up charger is a trailer-mounted pop-up charger.

In some aspects, the techniques described herein relate to a pop-up charger management method, further including, in response to the expected charge demand, communicating a location of another pop-up charger to one or more of the vehicles within the plurality of vehicles.

In some aspects, the techniques described herein relate to a pop-up charger management method, further including, in response to the expected charge demand, communicating a request for another pop-up charger.

In some aspects, the techniques described herein relate to a pop-up charger management method, further including charging the plurality of electrified vehicles from the pop-up charger.

In some aspects, the techniques described herein relate to a pop-up charger management method, wherein the generator is a 150-kilowatt generator.

In some aspects, the techniques described herein relate to a pop-up charger management method, further including communicating a fee for charging from the pop-up generator.

In some aspects, the techniques described herein relate to a pop-up charger management method, wherein the fee is an estimated fee.

In some aspects, the techniques described herein relate to a pop-up charger management method, further including changing the fee based on the expected charge demand.

In some aspects, the techniques described herein relate to a pop-up charger management method, further including lowering the fee when a demand for charging from the pop-up charger decreases.

In some aspects, the techniques described herein relate to a pop-up charger management method, prior to the assessing, communicating a pop-up charging event notification from the pop-up charger.

In some aspects, the techniques described herein relate to a pop-up charger management method, further including communicating the pop-up charging event notification to the plurality of vehicles.

In some aspects, the techniques described herein relate to a pop-up charger management method, wherein the pop-up charging event notification includes a start time, an end time, and a location.

In some aspects, the techniques described herein relate to a pop-up charger management method, further including receiving a charging reservation from at least one of the plurality of vehicles.

In some aspects, the techniques described herein relate to a pop-up charger management method, further including communicating a reservation alerting notification from the pop-up charger.

In some aspects, the techniques described herein relate to a pop-up charger management method, further including, in response to the expected charge demand, offering an incentive for at least one of the plurality of vehicles to reduce an amount of charging from the pop-up charger.

In some aspects, the techniques described herein relate to a charger assembly, including: at least one generator; at least one battery; a control module configured to, in response to an expected charge demand, start the at least one generator, the expected charge demand based on communications from a plurality of electrified vehicles.

In some aspects, the techniques described herein relate to a charger, wherein the charger assembly is portable.

In some aspects, the techniques described herein relate to a charger, wherein the charger assembly is vehicle-mounted.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a highly schematic view of a pop-up charger charging a plurality of electrified vehicles.

FIG. 2 illustrates a perspective view of an exemplary pop-up charger that is vehicle-mounted.

FIG. 3 illustrates a perspective view of an exemplary pop-up charger that is trailer-mounted.

### DETAILED DESCRIPTION

This disclosure details a charger and, in particular, a pop-up charger along with methods of managing the pop-up charger.

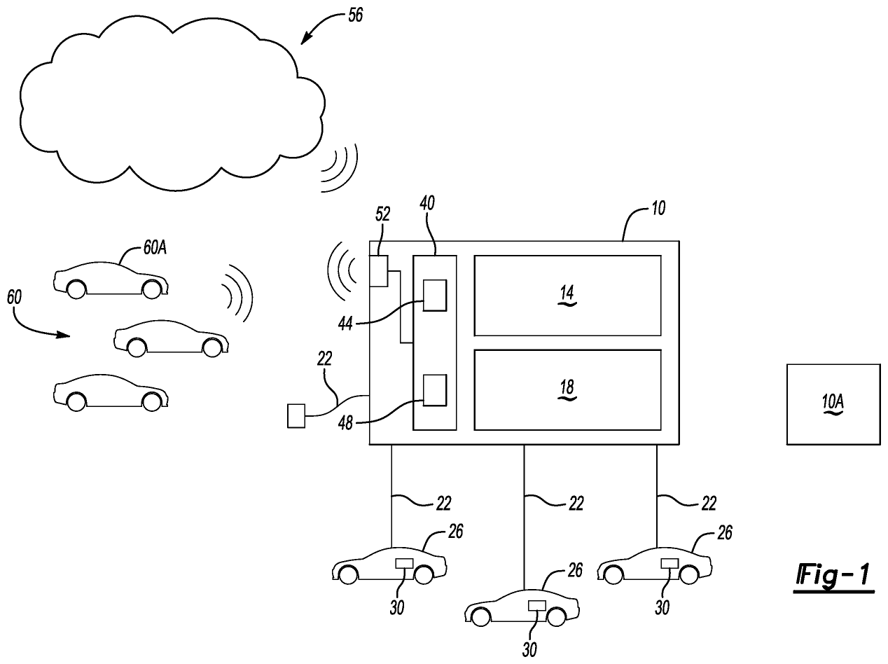

With reference to FIG. 1, an example pop-up charger 10 is a type of charger, The pop-up charger 10 includes a generator assembly 14 and a charger battery 18. The generator assembly 14 can be operated to generate electrical energy that can be stored in the charger battery 18.

Generally, a pop-up charger is a large battery that can be dropped anywhere not needing a connection to the electrical grid. The large battery can supply large amounts of electrical power to fast charge (150 kW) a vehicle or vehicles. A pop-up charger can have a generator and a fuel source.

In this example, Electric Vehicle Supply Equipment (EVSE) 22 can be used to electrically couple one or more electrified vehicles 26 to the pop-up charger 10. Electrical energy from the pop-up charger 10 can then be used to charge traction batteries 30 of the electrified vehicles 26.

In some examples, the pop-up charger 10 can simultaneously charge twenty of the electrified vehicles 26. The pop-up charger 10 is portable and, as required, can be moved to areas likely to have vehicles that need to be charged. The generator assembly 14 is a 150-kilowatt generator in this example. In some examples, the pop-up charger 10 can electrically connect to an electrical grid and can supplement electrical energy generated by the generator assembly 14 with electrical energy from the grid.

The pop-up charger 10 can be deployed to areas where an increased energy demand is forecast. An example could include an area near a concert or festival having a number of vehicles.

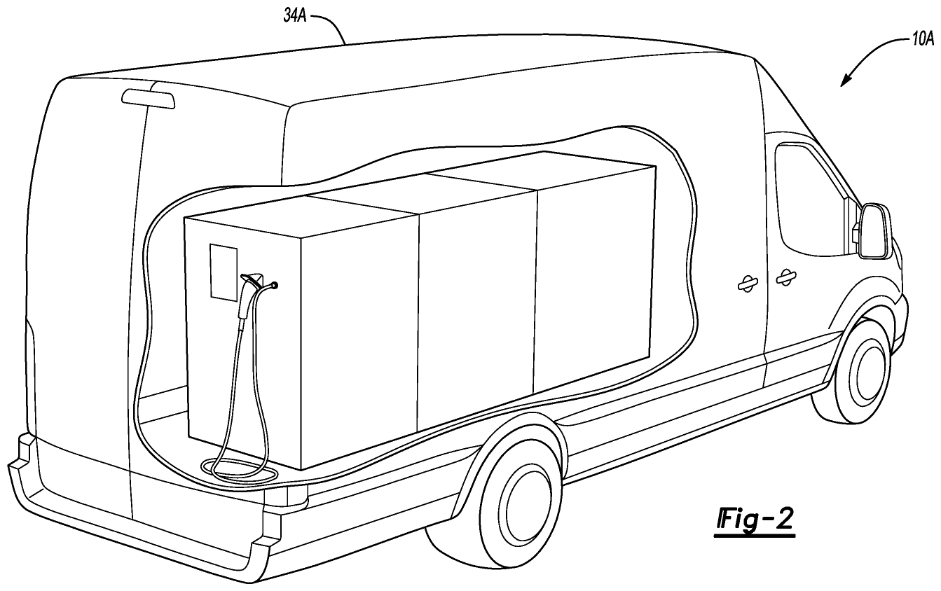

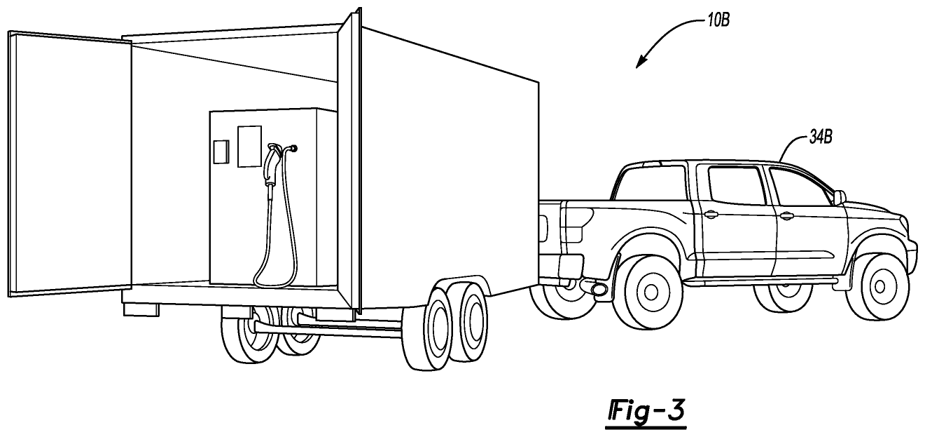

FIG. 2 shows an example of the pop-up charger 10 as a vehicle-mounted pop-up charger 10A where the pop-up charger is part of a motor vehicle 34A. FIG. 3 shows an example of the pop-up charger 10 as a trailer-mounted pop-up charger that can be towed by a motor vehicle 34B.

Referring again to FIG. 1, the pop-up charger 10 includes a pop-up charger control module 40 having at least a processing unit 44 and non-transitory memory 48 for executing various control strategies and modes. The processing unit 44 can be programmed to execute one or more programs stored in the memory 48. The program may be stored in the memory 48 as software code, for example. Each program stored in the memory 48 may include an ordered list of executable instructions for implementing logical functions associated with managing operations of the pop-up charger 10. The processing unit 44 can be a custom made or commercially available processor, a central processing unit (CPU), or generally any device for executing software instructions. The memory 48 can include any one or combination of volatile memory elements and/or nonvolatile memory elements.

The pop-up charger 10, in the exemplary embodiment, additionally includes a transceiver 52 that can send and receive communications. The control module 40 is operably couple to the transceiver and, through the transceiver 52, can communicate with cloud-based services, applications, or resources 56.

The control module 40 can send communications to, and receive communications from, the vehicles 26 that are recharging from the pop-up charger 10. The control module 40 can, through the transceiver 52, send communications to, and receive communications from, other vehicles 60 that are not electrically coupled to the pop-up charger 10.

The control module 40, in the exemplary embodiment, assesses an expected charge demand based on communications from the vehicles 60, the vehicles 26, or both. The expected charge demand reflects how much electrical energy will be required from the pop-up charger 10 within a set time, say the next four hours. Communications from one of the vehicles 60A could reveal that the traction battery of that vehicle 60A need to be recharged from a twenty-percent state of charge (SOC) to an eighty-percent SOC. An operator of the vehicle 60A can initiate the request and adjust how much recharging is requested.

The control module 40 can aggregate requests from the vehicles 60 and the vehicle 26 to establish the expected charge demand. In response to the expected charge demand, the control module 40 can start the generator assembly 14. The control module 40 may start the generator assembly 14 when the expected demand exceeds a threshold level, for example.

The control module 40, in some examples, transmits a communication to the vehicle 60A indicating that the vehicle 60A is authorized to charge. In response, the vehicle 60A can travel to the location of the pop-up charger 10, electrically connect to the pop-up charger 10 through EVSE 22, and recharge a traction battery of the vehicle 60A along with the other vehicles 26.

The control module 40 can take other actions in response to the expected charge demand. For example, the expected charge demand may exceed what the pop-up charger 10 can provide even when operating the generator assembly 14. Accordingly, after receiving a charge request from the vehicle 60A and calculating the expected charge demand, the control module 40 may send a communication to the vehicle 60A. The communication could let a user of the vehicle 60A know that the pop-up charger 10 cannot meet the request, and could reveal the location of another pop-up charger 10A to the user. The revealing could include providing directions or an address on a display within the vehicle 60A. The pop-up charger 10 could also request that the vehicle 26, 60, 60A add electrical energy to the pop-up charger 10 rather than charge from the pop-up charger 10.

The control module 40 can take other actions in response to the expected charge demand. For example, in response to the expected charge demand, the control module 40 could communicate a request for another pop-up charger. The other pop-up charger could be required to meet the expected charge demand. The other pop-up charger could be dispatched in response to the communication from the control module 40.

Communications between pop-up charger 10 and the vehicles 26, 60, 60A can include various other types of information. The communications could include fees associated with charging from the pop-up charger 10. The fees could be actual fees, estimated fees, or both. In an example, an estimated fee for a full recharge of the traction battery in the vehicle 60A from the pop-up charger 10 is sent from the pop-up charger 10 to the vehicle 60A after the pop-up charger 10 receives a charge request from the vehicle 60A. This fee is sent in a communication to the vehicle 60A. The communication, and the remaining communications mentioned in this disclosure, could pass through the cloud 56.

Notably, the fee can be dynamic and could change based on, for example, the expected charge demand. The fee for charging from the pop-up charger 20 could be lowered when a demand for charging from the pop-up charger 10 decreases. The fee for charging from the pop-up charger 10 could be raised when a demand for charging from the pop-up charger 10 increases.

In some examples, the users of the vehicles 26 may, during a charge, receive a notification that they are approaching or have reached an allocated amount of charge, and that the price for charging will increase if the charging is continued. If the user does not agree to the enhanced price rate, the pop-up charger 10 may stop charging that vehicle 26.

The communications between the pop-up charger 10 and the vehicles 26, 60, 60A could include a notification that is broadcast to, particularly the vehicles 60 from the pop-up charger 10. The notification could alert the vehicles 60 and let the vehicles 60 know that the pop-up charger 10 is available for charging. The notification could be considered a pop-up charging event notification. The notification could be sent prior to assessing an expected charge demand. The notification could include a start time for charging from the pop-up charger 10, an end time for charging from the pop-up charger 10, and a location or directions to the pop-up charger 10. The notification could include a preferred payment or transaction type (e.g., pay per hour, flat fee, etc.). The notification could require the user to agree to terms and conditions or to otherwise confirm their reservation.

In response to the notification, the vehicles 60 could send charging reservation requests to the pop-up charger indicating that the vehicles 60 would like to charge from the pop-up charger 10. The control module 40 can base the expected charge demand, at least in part, on the charge reservation requests received from one or more of the vehicles 60. The pop-up charger 10 could communicate a reservation alerting notification back to the vehicles 60 to confirm or deny the charge reservation request.

The control module 40 can take other actions in response to the expected charge demand. For example, in response to the expected charge demand, the control module 40 could communicate a request to one of the vehicle 26, 60, 60A to reduce an amount of their charging. The communication could offer an incentive, such as reducing the fees for the vehicle 26, 60, 60A to charge from the pop-up charger 10 if the vehicle 26, 60, 60A agrees to reduce the amount of electrical energy required, or the reduce an amount of time spent charging from the pop-up charger 10.

In some examples, the pop-up charger 10 only communicates with vehicles that have been enrolled in a pop-up charge program. That is, the users need to, in some examples, indicate that the vehicle the user is operating should receive a notification from the pop-up charger. The pop-up charger 10 can also, in some examples, only communicate with vehicles 26, 60, 60A that within a particular distance from the pop-up charger 10, or vehicles 26, 60, 60A that will not have disruptions to planned trips if interrupted to drive to the location of the pop-up charger 10.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A pop-up charger management method, comprising:
assessing an expected charge demand based on communications from a plurality of electrified vehicles; and
in response to the expected charge demand, starting at least one generator of a pop-up charger.

2. The pop-up charger management method of claim 1, wherein the pop-up charger is a vehicle-mounted pop-up charger.

3. The pop-up charger management method of claim 1, wherein the pop-up charger is a trailer-mounted pop-up charger.

4. The pop-up charger management method of claim 1, further comprising, in response to the expected charge demand, communicating a location of another pop-up charger to one or more of the vehicles within the plurality of vehicles.

5. The pop-up charger management method of claim 1, further comprising, in response to the expected charge demand, communicating a request for another pop-up charger.

6. The pop-up charger management method of claim 1, further comprising charging the plurality of electrified vehicles from the pop-up charger.

7. The pop-up charger management method of claim 1, wherein the generator is a 150-kilowatt generator.

8. The pop-up charger management method of claim 1, further comprising communicating a fee for charging from the pop-up generator.

9. The pop-up charger management method of claim 8, wherein the fee is an estimated fee.

10. The pop-up charger management method of claim 9, further comprising changing the fee based on the expected charge demand.

11. The pop-up charger management method of claim 10, further comprising lowering the fee when a demand for charging from the pop-up charger decreases.

12. The pop-up charger management method of claim 1, prior to the assessing, communicating a pop-up charging event notification from the pop-up charger.

13. The pop-up charger management method of claim 12, further comprising communicating the pop-up charging event notification to the plurality of vehicles.

14. The pop-up charger management method of claim 12, wherein the pop-up charging event notification includes a start time, an end time, and a location.

15. The pop-up charger management method of claim 12, further comprising receiving a charging reservation from at least one of the plurality of vehicles.

16. The pop-up charger management method of claim 15, further comprising communicating a reservation alerting notification from the pop-up charger.

17. The pop-up charger management method of claim 1, further comprising, in response to the expected charge demand, offering an incentive for at least one of the plurality of vehicles to reduce an amount of charging from the pop-up charger.

18. A charger assembly, comprising:
at least one generator;
at least one battery; and
a control module configured to, in response to an expected charge demand, start the at least one generator, the expected charge demand based on communications from a plurality of electrified vehicles.

19. The charger assembly of claim 18, wherein the charger assembly is portable.

20. The charger assembly of claim 18, wherein the charger assembly is vehicle-mounted.
